(19) United States
(12) Patent Application Publication
(10) Pub. No.: US 2011/0306423 A1
(43) Pub. Date: Dec. 15, 2011

(54) MULTI PURPOSE WIRELESS GAME CONTROL CONSOLE

(76) Inventor: Isaac Calderon, San Diego, CA (US)

(21) Appl. No.: 12/813,259

(22) Filed: Jun. 10, 2010

(51) Int. Cl. A63F 13/06; A63F 13/04

(52) U.S. Cl. 463/37; 463/39

(57) ABSTRACT

A remote control game console device for remotely controlling a media device is provided. A related system and method is included. The device includes a body, circuitry and multiple control input mechanisms that generate and send control signals to a media device by wireless communications. The multiple control input mechanisms include a keyboard, mouse, directional pad, joystick, motion sensor and other controls for selecting and controlling modes of the remote control device and for controlling the play of games on the media device. The remote console further provides a system and method for controlling video games with a single remote, wireless controller in multiple modes and combinations across a broad range of games.

### FIELD OF THE INVENTION

The present invention pertains generally to wireless control of video games via a remote control game console that includes multiple controls for multiple types of games. More particularly, the invention pertains to using a remote control console including a keyboard, joystick, trackball mouse, directional pad and motion sensor, as well as a mode selector for selecting from among various combinations of the controllers. The present invention is particularly, but not exclusively, useful as a console, system and method for controlling video games with a single remote, wireless controller in multiple modes for play in any selected combination.

### BACKGROUND OF THE INVENTION

Various forms of remote controls for game playing devices for playing personal computer games and online computer games are available. Such games allow controls via various forms of input, such as via a keyboard, mouse, joystick, directional pad, motion sensor and other controls. Many of these controls can be provided by more than one form of input, for example, a keyboard can be used for inputting text, as well as for inputting directional and other controls, while a joystick, mouse, directional pad and motion sensor can also be used for such directional controls. Game consoles exist with multiple means of control and forms of input. However, an important factor in considering the utility of such remote control devices are the range of inputs and modes available in the devices and the ease of using the device to control media devices. Problems arise where multiple remote control devices are required to provide a variety of control signals and to play games in difference modes. Problems also arise where multiple control devices are required to satisfy user's various preferences, such as their preferred mode of input of text, directional controls, their preferred hand or fingers for various functions, or their preferred games and the requirements for those games. Problems arise given the wide variety of games available on media devices, which provide a wide array of input and control devices and options. Consolidation of as many options as possible into a single, flexible, convenient device is desirable.

In light of the above, an object of the present invention is to provide a small, handheld remote control device for generating control signals from multiple input mechanisms based on multiple modes selected by the user of the remote control device based on their preference. It is another object of the present invention to provide a device and system that provides essentially all input options in a single remote device, and allows the user to set up and use the device and system based on their preferred manner of play and the games they desire to play.

Yet another object of the invention is to provide such a remote game console, including a keyboard, trackball mouse, directional pad, joystick and motion sensor, with selectable modes wherein the functionality of each input device can be enabled or disabled as well as switched between them. Yet another object of the invention is to provide the remote control console in a compact, self contained arrangement, whereby all controls and features can be easily reached and controlled to the same effect as if multiple separate controls were being used. Yet another object of the invention is to provide a system in which to use this device, including various possible game devices and games, such as personal computer games and online games. Yet another object of the invention is to provide such a device, system and method that is easy to use, simple to install and comparatively cost effective.

### SUMMARY OF THE INVENTION

In accordance with the present invention, a wireless game control console device is provided. The remote console has multiple control signal input mechanisms mounted on the body of the console. It further includes circuitry to generate the control signals based on the engagement of the input mechanisms by the player. The circuitry also controls the mode of the device based on the modes selected by the player.

The control signal input mechanisms vary broadly so as to encompass the major controls used for computer games. For example, they include keyboard with standard keys (QWERTY keyboard, ASWD keys, directional keys) used in most computer games to control menus, screens, images, the cursor and characters. The remote console of the present invention further includes a mouse (such as a trackball mouse), joystick and directional pad. Depending on the mode selected, these provide controls corresponding to joystick and ASDW keys and up, down, right and left arrow keys of a conventional keyboard. The remote device further includes a motion sensor for generating control signals. The remote sensor includes accelerometers to detect motion of the console for generating signals corresponding to horizontal and vertical movement according to the game being played and controlled. To communicate with the game device, the present invention includes a transmitter in the remote console for wirelessly communicating with a receiver. The receiver is in communication with the game device, such as by a USB cable, wherein the transmitter provides control signals from the remote device to the media device via the receiver. This receiver receives control signals from multiple input devices of the console (e.g., keyboard, joystick, mouse, directional pad, motion sensor).

Further, the remote console device of the present invention is configured to be set and used in several different modes. Based on the mode selected, the remote console can be used in many different ways according to the user's preference. For example, a user may prefer one set of controls for the left hand and another for the right hand and switch the respective modes of the directional pad and joystick. A user may disable certain input control mechanisms in favor of others. A user may play a game with certain features that highlight motion controls, such as driving or flying games.

The control mechanisms of the remote console device are also arranged for the user's convenience. For example, in addition to all input mechanisms being located on one device, they are arranged for easy hand and finger access. By further example, the mouse is mounted on the front of the body and the right and left click buttons and associated game keys are located on the top of the device two handed remote play. These keys can also be used in a joystick mode to generate signals representing joystick buttons.

Further, in the present invention, the motion sensor can be enabled and disabled based on the style of play preferred, and the mode of the sensor can be selected from among a drive and fly mode for driving and flying games. The sensor can detect and send control signals for both horizontal and vertical movement.

The console device further includes a variety of specific keys and inputs for basic game operation, such as keys for opening and closing game applications and minimizing and maximizing game applications and associated images, screens and menus.

The system and method of the present invention includes the console device in use with a game device. The system and method are used to provide control signals to a game device in multiple modes and to switch among modes in between providing control signals to a game device.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a situational view of the wireless game control console device and system of the present invention;

FIG. 2 is a perspective view of the wireless game control console device of the present invention;

FIG. 3 is a side view of the wireless game control console device of the present invention;

FIG. 4 is a back side view of the wireless game control console device of the present invention;

FIGS. 5A-I are illustrations of the fly and drive mode of the wireless game control console device of the present invention;

FIG. 6 is a flow chart showing the circuitry of the wireless game control console device of the present invention;

FIG. 7 is a perspective view of the receiver of the present invention; and

FIG. 8 is an exploded perspective view of the game control console device of the present invention.

### DESCRIPTION OF THE PREFERRED EMBODIMENTS

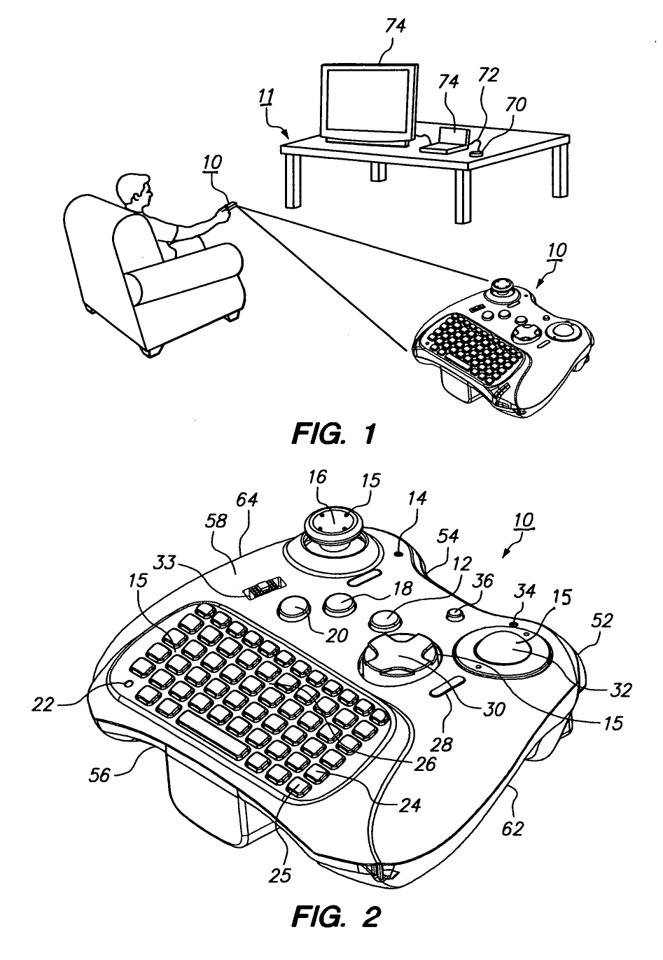

As shown in FIG. 1, system 11 of the present invention includes the handheld game console device 10 to control a game media device 74 (e.g. 74a, 74b), such as a computer system, computer game system or Internet television system. General dimensions for device 10 include about 6-9 inches in width, 5-7 inches in length and 1.5-3 inches in thickness. As such, the device 10 can easily be held in a user's hands. However, the dimensions of device 10 may vary beyond those ranges.

As further shown in FIG. 2, device 10 includes multiple control signal input mechanisms 15 for remotely controlling media device 74 in multiple modes and configurations. As explained in more detail below, control signal input mechanisms 15 include at least a keyboard 26, directional pad 30, mouse 32, joystick 16 and motion sensor 39.

As also shown in FIG. 1, device 10 is in wireless communication with game media device 74. Device 10 transmits control wireless signals to receiver 70. Receiver 70 is connected to media device 74 via USB cable 72 and transmits control signals received from device 10 to media device 74 via USB cable 72.

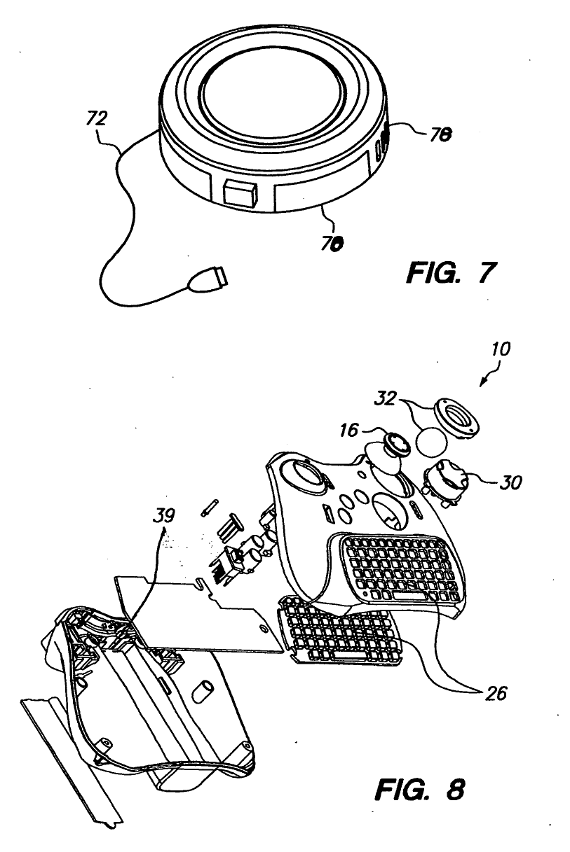

FIG. 7 also shows receiver 70, including USB cable 72 and receiver status lights 78 indicating the status of connection. USB cable 72 fits USB port for media device 74, which can be any variety of media devices as explained above. Receiver 70 is preferably comprised of 2.4 GHz wireless module.

As indicated by FIG. 1, device 10 pairs with receiver 70 in order to establish a connection. The pairing process achieves a wireless connection between device 10 and receiver 70 using for example 2.4 GHz wireless protocol. Other wireless protocols may be used, such as Zigbee and Infrared.

The pairing process is accomplished by turning on the power on the device 10 by engaging (e.g., pressing) any of its control signal input mechanisms 15. To indicate that the power of device 10 is turned on, LED lights on device 10, such as status indicators 28 or 34, are configured to start to flash, which also indicates that there is no connection yet with receiver 70 although the power of device 10 is on. Next, the device 10 is configured so that certain combinations of keys of the control signal input mechanisms 15 may be engaged to complete the pairing process. For example, in a preferred embodiment, the joystick 16 and mode selector 36 of the device are simultaneously engaged for a few seconds to prompt device 10, including transmitter 86 (see FIG. 6), to look for receiver 70 by transmitting signals. The light of status indicator (e.g., 28, 34) may be configured to start to flash at a certain rate, which indicates that the device 10 has been powered on and is transmitting signals to attempt to pair with receiver 70. When device 10 finds receiver 70, that is, the transmitted signals of device 10 are received and acknowledged by receiver 70, device 10 and receiver 70 are paired. To visually indicate when this pairing occurs, a status indicator (e.g., 28, 34), such as an LED or other light, may be configured to change from flash to steady light. Alternatively, status lights may be configured to stop flashing when pairing has been established.

As also shown in FIG. 2, device 10 includes a power button 12. Power button 12 is pressed to turn device 10 on, and pressed and held for a certain time period or beyond a certain time period to turn device 10 off. Device 10 may be configured to enter into sleep mode after 10 minutes of inactivity, and to leave sleep mode upon pressing any key of device 10 (to wake up).

As shown in FIG. 2, device 10 is comprised of a body 52, which includes at least a top 54, bottom 56, front 58, right side 62 and left side 64. As shown further in FIG. 4, the body 52 of device 10 also includes a back 60. As shown in FIG. 4, back 60 of device 10 includes battery cover 50, and batteries 48 are housed in a battery compartment covered by battery cover 50. Device 10 is preferably made of plastic materials, but any material sufficient to provide a structurally sound frame for a handheld device for light hand and finger use will suffice.

As shown further in FIG. 2, and as referenced above in connection with FIG. 1, device 10 includes a plurality of control signal input mechanisms 15. Each control signal input mechanism 15 is individually positioned at a location on the body 52 of device 10. Each control signal input mechanism 15 is electronically connected to the media device 74 (as shown and described for FIG. 1, FIG. 6, and FIG. 7). Each input mechanism 15 generates a set of unique control signals for controlling the media device 74.

As shown further in FIG. 2, device 10 includes at least one key for switching one or more control signal input mechanisms 15 between functions or modes. For example, mode selector key 36 is configured to provide this switch between functions or modes. Mouse status indicator 34 or other indicators is configured on device 10 for indicating a mode of a control signal input mechanism 15.

As shown in FIG. 2, at least one control signal input mechanism 15 comprises keyboard 26, which includes various keys for different characters and functions. The purpose of keyboard 26 is to generate control signals for commands, searches, other text and other symbols and for cursor controls. Keyboards for use to control games are well-known. Keyboard 26 preferably comprises a QWERTY layout keyboard, although other layouts can be used. Keyboard 26 includes a shift key, which when pressed together with any key with secondary characters, provides the secondary character when the key is engaged. Keyboard 26 also includes a capital key, which when engaged provides capital characters, and a caps indicator 22 (e.g., an LED indicator light) is provided on body 52 which indicates when caps are enabled/disabled.

In an alternative embodiment, keyboard 26 also includes at least one key (e.g., sym key) for switching the keyboard 26 between multiple sets of characters or other symbols represented by the engagement of the keys of the keyboard 26. Keyboard 26 also includes an enter key 24, for generating enter control signals. Device 10 may also include at least one additional enter key offset from keyboard 26, including for the same purpose as enter key 24, but for alternative access. For example, directional pad 30, mouse 32, joystick 16 and motion sensor 39 may provide enter key functions.

As also shown in FIG. 2, at least one control signal input mechanism 15 further comprises a mouse 32. Mouse 32 is for generating control signals to control movement of a cursor on a display of the media device 74. As also shown in FIG. 2, mouse 32 is mounted on the front 58 of the body 52 like keyboard 26, and mouse 32 is preferably a trackball mouse, as also shown. Components for such mouses are commercially available.

The body 52 and front 58 of the body 52 of the device 10 are designed to fit the mouse 32, such as by securely inserting the components into openings in the front 58 of the body 52. In a preferred embodiment, mouse 32 is enabled by default upon powering up the device 10 but can be disabled when certain modes are selected as explained below.

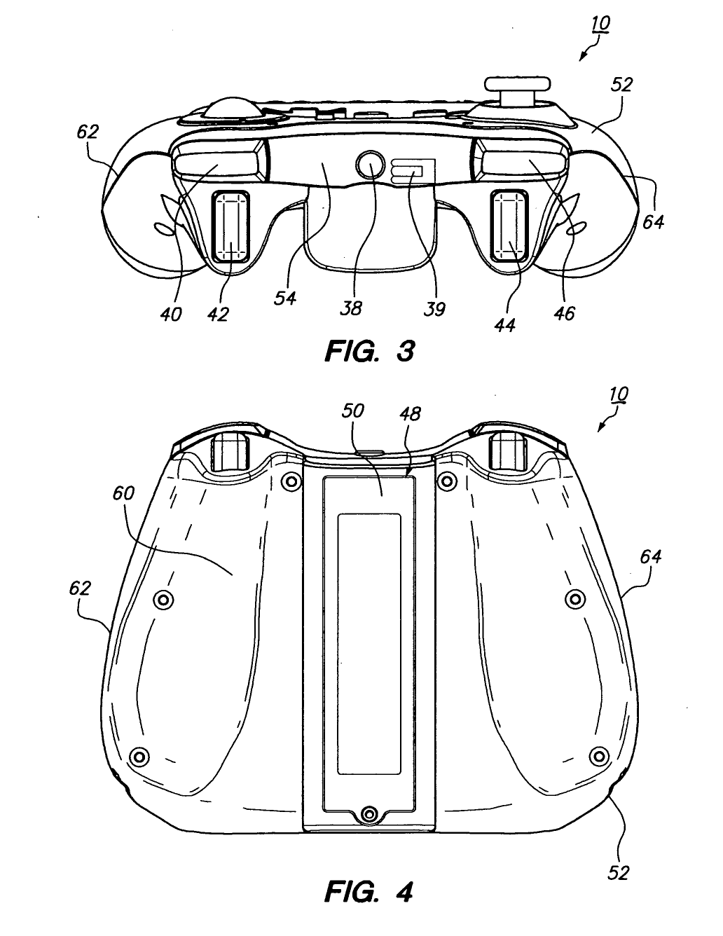

Mouse 32 is used in conjunction with at least two buttons for generating control signals to control the cursor on a display of the media device 74. Similar to conventional mouses used for computers and gaming, mouse 32 is used in connection with right and left click buttons. In particular, as shown in FIG. 3, on top 54, device 10 includes right upper button 40, left upper button 46, right lower trigger 42 and left lower trigger 44. These buttons may be configured as right and left click buttons of mouse 32, as well as trigger buttons and as a shift key and a space bar. For example, the two right buttons 40 and 42 are mounted on the top 54 of the body 52 and separate from the keyboard 26 for generating control signals corresponding to the engagement of right click and left click buttons of the mouse 32 in certain modes and triggers in modes where the mouse 32 is disabled, as explained further below (e.g., buttons 1 and 3 in third mode discussed below). The two left buttons 46 and 44 are mounted on the top 54 of the body 52 and separate from the keyboard 26 for generating control signals corresponding to engagement of a shift key and space bar in certain modes.

As also shown in FIG. 2, device 10 also includes a mouse speed switch 33. This is preferably a three step switch that allows adjustment of the speed of mouse 32. For example, mouse speed switch 33 allows the user of device 10 to adjust in real-time the speed of the mouse 32 (e.g., between slow, medium and fast) to adjust for different gaming preferences and requirements. As shown in FIG. 2, mouse speed switch 33 is preferably positioned on the front 58 of device 10 opposite the mouse 32 and below the joystick 16, so that the switch 33 can be adjusted with one hand while using the mouse 32 with the other hand.

As also shown in FIG. 2, at least one control signal input mechanism 15 comprises a directional pad 30. Directional pad 30 is preferably a directional arrow pad, as shown, having arrows up, down, left and right incorporated within the directional pad 30. As shown, directional pad 30 preferably is generally flat, finger or thumb-operated directional control. Such directional pads are commonly found on game and television controllers. Combinations of two or more directions (up and left, for example) can be used to provide diagonals in addition to up, down, left and right directional control signals.

Components for such directional pads are commercially available. The function of directional pad 30 is to provide control signals to the media device 74, including preferably directional controls (e.g., X and Y direction (direction or motion occurs along X and/or Y axes), rotation around X and Y axes (direction or motion rotates on the X and/or Y axes)). More specifically, the directional pad 30 is for generating control signals corresponding to a general joystick controller, A, S, D and W text keys of a general key board and up, down, right and left arrow keys on a general keyboard based on the mode of the device 10 based on engagement of the directional pad 30. General joystick controllers and general keyboard and corresponding control signals referred to above and elsewhere herein refer to joysticks and keyboards in general. These are inclusive of but not limited to joystick 16 and keyboard 26.

As explained further below, directional pad 30 generates control signals based on the mode selected by mode selector 36 and/or motion sensing button 38. When directional pad 30 is used as a joystick controller, it generates directional control signals corresponding to a general joystick controller (e.g., up, down, left, right and directions in between, X and Y direction, rotation around X and Y axis). When directional pad 30 is used as an A, S, D and W input, it generates control signals corresponding to A, S, D and W similar to general keyboard character controls for entry of these keys (“ASDW”). It is well-known that video and computer games use ASDW keys as control signals for directional and other controls. When directional pad 30 is used to generate control signals corresponding to arrow keys, this control is similar to use of a keyboard's arrows keys for directional control (e.g., up/down, right/left, X/Y direction, X/Y rotation (“Arrows”)), except that the directional pad 30 provides separate and specific controls dedicated to directions and can provide diagonals. In these modes, directional pad 30 is for generating control signals to control the direction of the cursor on the display of the media device 74, the point of view of the display of the media device 74 and the image size of the display of the media device 74.

In the embodiment shown in FIG. 2, directional pad 30 is mounted on the front 58 of the body 52, like the keyboard 26 and mouse 32. The body 52 and front 58 of the body 52 of the device 10 are designed to fit the directional pad 30, such as by securely inserting the components into openings in the front 58 of the body 52.

As also shown in FIG. 2, at least one control signal input mechanism 15 comprises a joystick 16. Joystick 16 is preferably a directional joystick device, as shown, having an arm portion and moveable in up, down, left and right directions relative to the front 58 of body 52. Joystick 16 also includes a push down button, preferably comprising part of the joystick 16 itself (e.g., the arm portion), which can be pressed downward into the body 52 as opposed to moving in such up, down, left and right directions.

As such, joystick 16 is preferably an analog joystick like those used in video game consoles consisting of a stick that pivots on a base and reports its angle or direction to the device it is controlling, such as media device 74 via device 10. Joysticks are often used to control video games, and usually have or are used in association with one or more push-buttons whose state can also be read by the computer. These commonly include five buttons (e.g., buttons 1, 2, 3, 4, 5), although more buttons can be incorporated, wherein each button provides control signals to perform a specific function dictated by a given game. Such 5-button programmable joysticks are well-known. For example, the 5-buttons are preset, set or programmed each with a state or function, such as 1-up, 2-down, 3-right, 4-left and 5-fire. Preferably, joystick 16, including the push down button feature of the joystick 16, in connection with buttons 40, 42, 44 and 46, emulate these buttons 1, 2, 3, 4, 5 for joysticks for gaming. These buttons (40, 42, 44 and 46, as well as push down arm/button of joystick 16) may be enabled or disabled by the mode selected by mode selector 36 or motion sensing button 38.

Joystick 16 is also capable of generating control signals corresponding to a hat switch, which is a common control on some joystick controllers. It is also known or referred to as a point of view hat. For example, the point of view hat allows a game player to look around in their virtual world, browse menus, etc. For example, many flight simulators use a point of view hat to switch the player's views. Directional pad 30 is also capable of generating control signals corresponding to such a point of view hat. This point of view hat functionality is switchable between the joystick 16 and directional pad 30. This functionality may also be enabled and disabled via by the mode selected by mode selector 36 or motion sensing button 38.

Components for such joysticks described above and useful for joystick 16 are commercially available. As described, the function of joystick 16 is to provide control signals to the media device 74, including preferably directional controls. More specifically, like the directional pad 30, joystick 16 is for generating control signals corresponding to a general joystick controller, ASDW keys of a general key board and Arrow keys on a general keyboard based on the mode of the device 10 based on the engagement of the directional pad 30. As for directional pad 30, joystick 16 also generates these control signals depending on the mode selected via mode selector 36 and motion sensing button 38.

In the embodiment shown in FIG. 2, joystick 16 is mounted on the front 58 of the body 52, like the keyboard 26, mouse 32 and directional pad 30. The body 52 and front 58 of the body 52 of the device 10 are designed to fit the directional joystick 16, such as by securely inserting the components into openings in the front 58 of the body 52.

As shown in FIG. 3, at least one control signal input mechanism 15 also comprises a motion sensor 39. Motion sensor 39 is preferably comprised in part of one or more accelerometers, which measure change in direction relative to level x, y and z axes for example. Such accelerometers are commercially available, such as those used in the popular I-Phone that senses change in position and generates signals to change views from portrait and landscape. As shown, motion sensor 39 is preferably located within the top 54 of the body 52 in a center portion under the motion sensor button 38, which activates the motion sensor 39 when pressed.

The function of motion sensor 39 is to detect the position of the device 10 relative to level horizontal and vertical axes and to provide control signals in response to provide directional control to the media device 74. More specifically, motion sensor 39 is for generating control signals corresponding to Arrows, including horizontal and vertical directions, motions and movements, based on the position of the motion sensor 39.

As referenced above, depending on the function or mode selected, each control signal input mechanism 15 has a function or mode, or in some cases one or more control signal input mechanisms 15 may be disabled. In a preferred embodiment, there are at least three modes controllable by the mode selector 36, including ASDW, Arrows and joystick modes which are switchable between directional pad 30 and joystick 16. Also, there are at least two modes controllable by motion sensor 39, including drive mode 68 and fly mode 66.

Accordingly, in a preferred embodiment, mode selector 36 can be used to select a first mode where by the control signal input mechanisms 15 have the following functions:

Mouse 32 is enabled to generate control signals to control the cursor on a display of the media device 74 as described above, and keys/buttons 40, 42, 46 and 44 are used to generate control signals corresponding respectively to right mouse click, left mouse click, shift key and space bar;

Joystick 16 is enabled to generate control signals corresponding to ASDW keys as described above (push down button of joystick 16 is disabled);

Directional pad 30 is enabled to generate control signals corresponding to Arrows as described above; and

Keyboard 26 is enabled to generate control signals for commands, text and other symbols and cursor controls as described above.

Accordingly, if a game on media device 74 requires or a user of device desires to use general mouse and ASDW keys as the primary controls of such a game, then this first mode is desirable so each hand of the user operates one control signal input mechanism 15.

Continuing with this preferred embodiment, mode selector 36 can be used to select a second mode where by the control signal input mechanisms have the following functions:

Mouse 32 is again enabled to generate control signals to control the cursor on a display of the media device 74 as described above, and keys/buttons 40, 42, 46 and 44 are used to generate control signals corresponding respectively to right mouse click, left mouse click, shift key and space bar;

However, joystick 16 is enabled to generate control signals corresponding to Arrows as described above (push down button of joystick 16 is again disabled);

And, directional pad 30 is enabled to generate control signals corresponding to ASDW keys as described above; and

Keyboard 26 is again enabled to generate control signals for commands, text and other symbols and cursor controls as described above.

Accordingly, if a game on media device 74 requires or a user of device 10 desires to use general mouse and Arrows keys as the primary controls of such a game, then this second mode is desirable so each hand of the user operates one control signal input mechanism 15.

Last, with respect to a third mode in this preferred embodiment, mode selector 36 can be used to select the third mode where by the control signal input mechanisms have the following functions:

Mouse 32 is disabled;

Keys/buttons 40, 42, 46 and 44 are used to generate control signals corresponding respectively to buttons 1, 2, 3 and 4 of a general game console;

Joystick 16 generates control signals corresponding to Arrows specifically with respect to rotational movement (e.g., X and Y rotation (rotations around X and Y axes) as discussed above, which are common control features on many games) and push down button of joystick 16 is enabled and works as button 5 of a general game console;

Directional pad 30 works as a point of view hat as explained above, that is, it generates control signals indicating the position and view of the cursor for games operating on media device 74; and

Keyboard 26 is again enabled to generate control signals for commands, text and other symbols and cursor controls as described above.

Accordingly, if a game on media device 74 requires or a user of device 10 desires to use a general joystick controller as the primary control of such a game, then this third mode is desirable.

The modes selected by mode selector 36 are preferably indicated by lights via mode status indicators 28. As shown in FIG. 2, one mode status indicator is placed close to joystick 16 and another is placed approximately between directional pad 30 and mouse 32. Mouse status indicator 34 is also preferably included to indicate whether the mouse is enabled or disabled. They are placed like this so the user can see the mode selected in reference to the control signal input mechanisms 15.

With respect to the drive and fly modes 68, 66 selectable by motion sensor button 38 and for which motion sensor 39 generates control signals, in a preferred embodiment, button 38 is pushed once to turn motion sensor 39 on and enable drive mode 68, pushed again to change to fly mode 66, and pushed again to turn motion sensor 39 off. As such, device 10 can be enabled to perform as a motion sensing controller to allow more realistic control and play of games on media device 74. This is possible even for games not designed specifically for motion sensing like driving or flying games.

When drive mode 68 is selected, the device 10 is preferably used as a steering wheel to generate control signals corresponding to side to side direction (horizontal motion). When fly mode 66 is selected, device 10 is used as a stick to generate control signals corresponding to vertical and horizontal direction (vertical and horizontal motion). When motion sensing is activated, it is preferable to enable mode three via mode selector 36 as described above. This way the device works to control all directional movement (X, Y and Z axis directions), including with motion sensor control 39 signals. For example, as explained above for the third mode, joystick 16 generates control signals for X and Y rotation and directional pad 30 generates control signals for point of view hat and motion sensor 39 provides additional control signals for horizontal direction or horizontal and vertical direction.

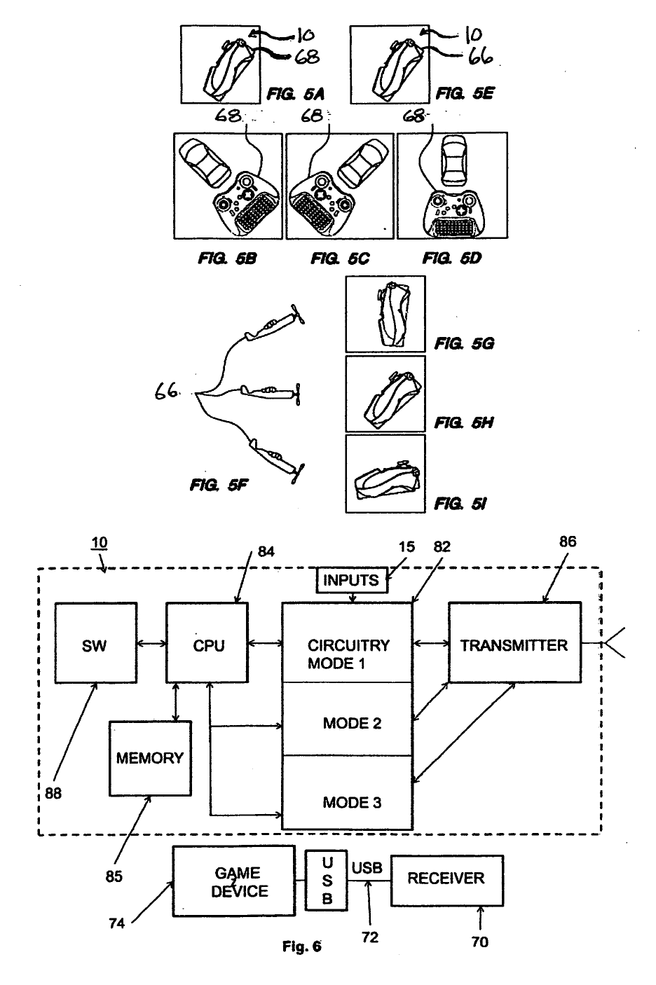

Drive mode 68 is further illustrated in FIGS. 5A to 5D. Fly mode 66 is further illustrated in FIGS. 5E to 51.

For drive mode 68, as shown in FIG. 5A, the device 10 is held in a naturally-angled vertical position just as one would grab a steering wheel, such as a 45° angle. To generate control signals indicating a left or right turn, device 10 is turned left to bear left (FIG. 5B), right to bear right (FIG. 5C) and held in a neutral vertical position to go straight (FIG. 5D). Joystick 16 is used to accelerate, brake or go back (this may vary depending on the game settings).

For fly mode 66, as shown in FIG. 5E, the device 10 is held in a naturally-angled vertical position, again about 45°. To generate control signals indicating vertical motion, device 10 is tilted upward (towards the user above the 45° neutral position) to go vertically up (FIG. 5G), held at 45° for neutral position for no change in motion or direction (FIG. 5H) and tilted downward to pitch in vertically downward (FIG. 5I). In fly mode 66, these vertical up/down movements can be combined with the side horizontal movements described for drive mode 68 to generate control signals indicating horizontal motion.

Accordingly, when the device 10 is in drive mode 68 or fly mode 66, the motion sensor 39 is configured to generate control signals directing no motion (e.g., stable, neutral) when the axis through the top 54 and bottom 56 of the device 10 (e.g., a central axis going through the center of the top 54 and bottom 56 of the device 10) is positioned at an angle of approximately 45° relative to level ground and approximately parallel to a plane 90° perpendicular to level ground. The motion sensor 39 is further configured to generate control signals indicating horizontal motion when this central axis is not positioned at an angle of approximately parallel to a plane 90° perpendicular to level ground. Additionally, when the device 10 is in fly mode 66, the motion sensor 39 is further configured to generate control signals indicating vertical motion when the central axis is positioned at an angle greater than or less than an angle of approximately 45° relative to level ground.

The various control signal input mechanisms 15 of device 10 (all buttons, triggers and other commands) can be used in various combination, depending on the game settings of games controlled on media device 74.

Similar to mode status indicators 28, motion sensing mode indicator 14 indicates that the motion sensing is on or off and also indicates if motion sensing is in drive or fly mode 66.

As also shown in FIG. 2, device 10 also includes an open key 18, and/or a home key 25, such as on keyboard 26, for generating control signals to select and display the home page of an application program in operation on the media device 74 and for maximizing a displayable image from an application program in operation on the media device 74. In other words, and using multiple game applications running on the media device 74 as examples, engaging the home key 25 or open key 18 can maximize the minimized application. Home key 25 or open key 18 can also be used to display the home page of the application.

As also shown in FIG. 2, device 10 includes escape key 20 to perform an escape function (e.g., executing the well-known escape function on a computer or media device running a program). As such, escape key 20 can be used to go back to the previous menu or to close screens. More specifically, escape key 20, when engaged, is for generating control signals to return to an image previously displayed on the media device 74 and for generating control signals to closing a screen displayed on the media device 74.

As shown in FIG. 6, device 10 includes circuitry 82 electronically connected to the control signal input mechanisms 15 for generating control signals in different selectable modes as explained above. Circuitry 82 is further electronically connected to CPU 84 for processing, memory 89 for storage and retrieval and software 88 for computing, programming and other software instructions and functions. Software 88 is programmable. Circuitry 82 is inclusive of and/or incorporates CPU 84, memory 89 and software 88 to the extent required for processing control signals, in that circuitry incorporates or is interoperable with each of these items as the electronic connections among the control signal input mechanisms 15.

As shown in FIG. 6, and as also discussed in view of FIG. 1 above, device 10 also includes a transmitter 86 for wirelessly communicating with receiver 70 that is in communication with the media device 74. The transmitter 86 provides control signals from the remote device 10 to the media device 74 via the receiver 70.

As shown further in FIG. 6, the device 10 includes a CPU 84 which provides processing of the various control signals processed by the device 10 and provides processing for transmitted control signals by transmitter 86 to receiver 70 and received signals from receiver 70.

As shown in FIG. 6, device 10 further includes software 88 for computing, instructing and processing (along with CPU 84) the various control signals generated and processed by the device 10. Device 10 further includes memory 89 for storing control signals and circuitry 82 for retrieving stored control signals from memory 89 via CPU 84 in response to control signals generated by one or more control signal input mechanisms 15.

In accord with the controls and functionality of device 10 described above, this memory 89 and circuitry 82 are configured for retrieving stored control signals in response to one or more subsets of control signals generated by one or more control signal input mechanisms 15, whereby CPU 84 provides processing. For example, circuitry 82 is configured for generating control signals in accord with the first, second and third preferred modes and fly and drive modes 66, 68 described above, depending on the mode selected via mode selector 36 and motion sensing button 38.

In accord with the description above, the device 10 also provides a method for remotely operating a media device 74. For example, the device 10 can be used in a method for remotely controlling the media device 74. As such, the device 10 can be used as a console in wireless communication to provide control signals to the media device 74. The device 10, through a plurality of control signal input mechanisms 15, generates a set of unique control signals for controlling the media device 74. The mode selector 36 on the body 52 of the device 10 is used to selectively engage each control signal input mechanism 15 with the media device 74, such as in different modes. The device 10 is used to control the media device 74 in multiple modes and to switch modes in between providing control signals to the media device 74.

FIG. 8 shows an exploded perspective view of the game control console device 10 of the present invention and its components, including components for the assembly of the keyboard 26, joystick 16, directional pad 30, mouse 32 and motion sensor 39.

While the particular system and method as herein shown and disclosed in detail is fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A console for controlling a media device which comprises:
a body;
a plurality of control signal input mechanisms, wherein each mechanism is individually positioned at a location on the body, and wherein each mechanism is electronically connected to the media device and generates a set of unique control signals for controlling the media device; and
a mode selector mounted on the body to selectively engage each control signal input mechanism with the media device.

2. A console as recited in claim 1 wherein the control signal input mechanisms further comprise:
a keyboard having keys for generating control signals upon engagement of the keys;
a mouse for generating control signals to control a cursor in accordance with engagement of the mouse;
a joystick for generating control signals corresponding to a joystick controller, A, S, D and W text keys and up, down, right and left arrow keys in accordance with the mode of the device upon engagement of the joystick;
a directional pad for generating control signals corresponding to a joystick controller, A, S, D and W text keys and up, down, right and left arrow keys based on the mode of the device upon engagement of the directional pad;
a motion sensor for generating control signals corresponding to up, down, right and left arrow keys in accordance with the position of the motion sensor.

3. A console as recited in claim 2 wherein the mode selector selects from among multiple modes and further comprises at least one mode key for selecting a mode and an indicator for indicating the mode of the console.

4. A console as recited in claim 3 wherein at least one mode key is for generating control signals to switch the respective modes of the directional pad and joystick between generating control signals corresponding to A, S, D and W text keys and up, down, right and left arrow keys.

5. A console as recited in claim 4 wherein at least one mode key is for generating control signals to disable either of the directional pad and joystick from generating control signals corresponding to A, S, D and W text keys and up, down, right and left arrow keys and to enable either of the directional pad and joystick to generate control signals corresponding to a joystick controller.

6. A console as recited in claim 5 wherein at least one mode key is for generating control signals to disable the mouse when the enabled mode of either the directional pad or joystick is for generating control signals corresponding to a joystick controller.

7. A console as recited in claim 2 wherein the body further comprises at least a front and a top and wherein the mouse is mounted on the front of the body and wherein the console further comprises buttons mounted on the top of the body and separate from the keyboard for generating control signals corresponding to the engagement of right click and left click buttons of the mouse and buttons mounted on the top of the body and separate from the keyboard for generating control signals corresponding to the engagement of a shift key and space bar.

8. A console as recited in claim 6 further comprising a center push-down button incorporated in the joystick wherein when the enabled mode of the joystick is for generating control signals for corresponding to a joystick controller, engaging the center push-down button generates control signals corresponding to a button 5 function of a joystick controller.

9. A console as recited in claim 6 wherein at least one mode key is for generating control signals to enable and disable the motion sensor.

10. A console as recited in claim 6 wherein at least one mode key is for switching the mode of the motion sensor between a drive mode and a fly mode, wherein in the drive mode, the motion sensor generates control signals directing horizontal motion of an image on a display of a media device in accordance with motion detected by the motion sensor, and in the fly mode, the motion sensor generates control signals directing vertical and horizontal motion of an image on a display of a media device in accordance with motion detected by the motion sensor.

11. A console as recited in claim 10 wherein, when the console is in drive mode, the motion sensor is configured to generate control signals directing no motion when the axis through the top and bottom of the console is positioned at an angle of approximately 45° relative to level ground and approximately parallel to a plane 90° perpendicular to level ground, and the motion sensor is further configured to generate control signals indicating horizontal motion when the axis through the top and bottom of the console is not positioned at an angle of approximately parallel to a plane 90° perpendicular to level ground.

12. A console as recited in claim 11 wherein, when the console is in fly mode, the motion sensor is configured to generate control signals indicating no motion when the axis through the top and bottom of the console is positioned at an angle of approximately 45° relative to level ground and approximately parallel to a plane 90° perpendicular to level ground, and the motion sensor is further configured to generate control signals indicating vertical motion when the axis through the top and bottom of the console is positioned at an angle greater than or less than an angle of approximately 45° relative to level ground.

13. A console as recited in claim 2 wherein the keyboard further comprises a QWERTY layout keyboard and the console further comprises an indicator that indicates when a capital letter mode is enabled or disabled on the keyboard.

14. A console as recited in claim 7 further comprising four buttons mounted on the top of the console and separate from the keyboard which are capable of generating control signals corresponding to button 1, button 2, button 3 and button 4 of a joystick controller.

15. A console as recited in claim 2 further comprising:
an open button for generating control signals to select and display the home page of an application program in operation on the media device and for generating control signals to maximize a displayable image of an application program in operation on the media device; and
an escape button for generating control signals to return to an image previously displayed on the media device and to close an image displayed on the media device and to otherwise execute an escape function on the media device.

16. A console as recited in claim 2 further comprising:
a transmitter for wirelessly communicating with a receiver that is in communication with a media device, wherein the transmitter provides control signals from the remote device to the media device via the receiver; and
circuitry electronically connected with the control signal input mechanisms, mode selector and transmitter for connecting the control signals.

17. A system comprising a console in communication with a media device, wherein the console comprises:
a body;
a plurality of control signal input mechanisms, wherein each mechanism is individually positioned at a location on the body, and wherein each mechanism is electronically connected to the media device and generates a set of unique control signals for controlling the media device; and
a mode selector mounted on the body to selectively engage each control signal input mechanism with the media device;
and the media device is selected from among the group of a computer system, a television system and an internet television system in communication with the console.

18. The system of claim 17 wherein the control signal input mechanisms further comprise:
a keyboard having keys for generating control signals upon engagement of the keys;
a mouse for generating control signals to control a cursor in accordance with engagement of the mouse;
a joystick for generating control signals corresponding to a joystick controller, A, S, D and W text keys and up, down, right and left arrow keys in accordance with the mode of the device upon engagement of the joystick;
a directional pad for generating control signals corresponding to a joystick controller, A, S, D and W text keys and up, down, right and left arrow keys based on the mode of the device in accordance with engagement of the directional pad;
a motion sensor for generating control signals corresponding to up, down, right and left arrow keys in accordance with the position of the motion sensor.

19. A method for remotely controlling a media device, the method comprising the step of using a console in wireless communication to provide control signals to a media device, wherein the console comprises:
a body;
a plurality of control signal input mechanisms, wherein each mechanism is individually positioned at a location on the body, and wherein each mechanism is electronically connected to the media device and generates a set of unique control signals for controlling the media device; and
a mode selector mounted on the body to selectively engage each control signal input mechanism with the media device; and
wherein the control signal input mechanisms include a keyboard, mouse, directional pad, joystick and motion sensor.

20. The method of claim 19 further comprising the steps of using the console to control the media device in multiple modes and to switch modes in between providing control signals to a media device.
